(19) United States
(12) Patent Application Publication
(10) Pub. No.: US 2026/0264743 A1
(43) Pub. Date: Sep. 10, 2026

(54) CORNER MODULE DUAL-MODE STEERING SYSTEM EQUIPPED WITH TWO-STAGE STEERING, AND DRIVING METHOD THEREOF

(71) Applicant: TSINGHUA UNIVERSITY, BEIJING (CN)

(72) Inventors: Jin HUANG, BEIJING (CN); Yanzhao SU, BEIJING (CN); Xingyu LI, BEIJING (CN); Yu FENG, BEIJING (CN)

(21) Appl. No.: 19/560,760

(22) Filed: Mar. 9, 2026

(30) Foreign Application Priority Data
Mar. 10, 2025 (CN) 202510276113.2

(51) Int. Cl. B62D 5/04; B62D 7/18

(52) U.S. Cl. CPC B62D 5/0418; B62D 7/18

(57) ABSTRACT

A corner module dual-mode steering system equipped with two-stage steering, and a driving method thereof are provided. A suspension is configured to be connected between a vehicle frame and a wheel hub. A primary drive mechanism is fixed to the suspension, and the primary transmission mechanism is configured to be connected to the wheel hub. The primary drive mechanism is configured to drive, via a primary transmission mechanism, the wheel hub to steer within a first angular range. A secondary steering drive assembly includes a secondary drive mechanism and a secondary transmission mechanism connected to the secondary drive mechanism. The secondary drive mechanism is configured to be fixed to the vehicle frame. The secondary transmission mechanism is connected to the suspension. The secondary drive mechanism is configured to drive, via the secondary transmission mechanism, the suspension and the wheel hub together to steer within a second angular range.

### CROSS-REFERENCE TO RELATED APPLICATION

The present application claims priority to Chinese patent application No. 202510276113.2, filed on March 10, 2025, the content of which is hereby incorporated by reference in its entirety.

### TECHNICAL FIELD

The present application relates to the technical field of corner modules, and in particular to a corner module dual-mode steering system equipped with two-stage steering, and a driving method thereof.

### BACKGROUND

With the development of vehicle intelligence, in order to achieve vehicle steering in narrow spaces, the steering angle of the wheel hub is required to increase as much as possible.

In the related art, a corner module includes a fixed rod, a rotary mounting rod, and a steering arm. The rotary mounting rod is mounted at the lower end of the fixed rod, and the steering arm is mounted on the outer side of the rotary mounting rod. During steering, the rotary mounting rod rotates about the fixed rod within a range of 0° to 90°, thereby driving the steering arm to rotate and enabling steering of a wheel mounted on the steering arm. A locking mechanism and a buffering mechanism can be further provided to fixedly lock the wheel steered by 90° and to prevent excessive impact resulting from an overly large steering of the steering arm.

However, the steering stability of the vehicle adopting the above-described corner module is relatively poor during high-speed driving.

### SUMMARY

In view of this, there is a need to provide a corner module dual-mode steering system equipped with two-stage steering.

A corner module dual-mode steering system equipped with two-stage steering, including:

a suspension configured to be connected between a vehicle frame and a wheel hub;

a primary steering drive assembly including a primary drive mechanism and a primary transmission mechanism connected to the primary drive mechanism, the primary drive mechanism being fixed to the suspension, the primary transmission mechanism being configured to be connected to the wheel hub, and the primary drive mechanism being configured to drive the primary transmission mechanism to move, such that the primary transmission mechanism causes the wheel hub to steer relative to the suspension within a first angular range;

a secondary steering drive assembly including a secondary drive mechanism and a secondary transmission mechanism connected to the secondary drive mechanism, the secondary drive mechanism being configured to be fixed to the vehicle frame, the secondary transmission mechanism being connected to the suspension, and the secondary drive mechanism being configured to drive the secondary transmission mechanism to move, such that the secondary transmission mechanism causes the suspension and the wheel hub together to steer within a second angular range.

In some embodiments, the suspension and the primary transmission mechanism are each spherically hinged to the wheel hub;

the suspension has a virtual kingpin axis and is rotatably connected to the wheel hub at the virtual kingpin axis, and the primary transmission mechanism is configured to drive the wheel hub to rotate about the virtual kingpin axis.

In some embodiments, the primary transmission mechanism includes a primary rocker arm and a primary connecting rod that are sequentially connected. One end of the primary rocker arm away from the primary connecting rod is connected to the primary drive mechanism, and one end of the primary connecting rod away from the primary rocker arm is spherically hinged to the wheel hub.

In some embodiments, a length of the primary connecting rod is adjustable.

In some embodiments, the suspension includes a first connection portion and a second connection portion, the first connection portion and the second connection portion are each configured to be spherically hinged to the vehicle frame, a line connecting the first connection portion and the second connection portion is defined as a virtual secondary kingpin axis, and the secondary transmission mechanism is configured to drive the suspension to rotate about the virtual secondary kingpin axis.

In some embodiments, the first connection portion is located at one end of the suspension in a vertical direction, the second connection portion is located at another end of the suspension in the vertical direction, and along the vertical direction, the secondary transmission mechanism is disposed between the first connection portion and the second connection portion.

In some embodiments, the secondary transmission mechanism is disposed on a side of the suspension away from the wheel hub.

In some embodiments, the secondary transmission mechanism includes a secondary rocker arm and a secondary connecting rod that are connected, one end of the secondary rocker arm away from the secondary connecting rod is connected to the secondary drive mechanism, and one end of the secondary connecting rod away from the secondary rocker arm is spherically hinged to the suspension.

In some embodiments, a length of the secondary connecting rod is adjustable.

In some embodiments, the secondary transmission mechanism has a locked state, and in the locked state of the secondary transmission mechanism, a rotation center of the secondary drive mechanism, a connection point between the secondary rocker arm and the secondary connecting rod, and a connection point between the secondary connecting rod and the suspension lie on a same straight line.

In some embodiments, the first angular range is -45° to +45°, and the second angular range is -45° to +45°.

A vehicle includes a vehicle frame, a wheel hub, and the above-described corner module dual-mode steering system equipped with two-stage steering, the suspension is rotatably disposed on the vehicle frame, and the wheel hub is rotatably disposed on the suspension.

A method for driving the above-described corner module dual-mode steering system equipped with two-stage steering is provided, wherein the corner module dual-mode steering system has a first operating state and a second operating state,

when the corner module dual-mode steering system is in the first operating state, the method includes: driving, via the primary drive mechanism, the primary transmission mechanism to move, and driving, via the primary transmission mechanism, the wheel hub to steer within the first angular range;

when the corner module dual-mode steering system is in the second operating state, the method includes: driving, via the primary drive mechanism, the primary transmission mechanism to move, and driving, via the primary transmission mechanism, the wheel hub to steer within the first angular range; driving, via the secondary drive mechanism, the secondary transmission mechanism to move, and driving, via the secondary transmission mechanism, the suspension and the wheel hub to steer simultaneously within the second angular range.

In the above-described corner module dual-mode steering system equipped with two-stage steering, and the driving method thereof, when the vehicle needs to park or make a turn under a low-speed condition, both the primary steering drive assembly and the secondary steering drive assembly are controlled to operate simultaneously, such that the primary drive mechanism drives, via the primary transmission mechanism, the wheel hub to steer within the first angular range, while the secondary drive mechanism drives, via the secondary transmission mechanism, the suspension and the wheel hub to steer within the second angular range. That is, the total steering angular range of the wheel hub is the sum of the first angular range and the second angular range, thereby significantly increasing the steering angular range of the wheel hub. When the vehicle, at a medium or high speed, travels normally or makes a turn, only the primary steering drive assembly is controlled to operate. The primary steering drive assembly is configured to drive the wheel hub to steer within a small angular range (i.e., the first angular range) so as to adapt to high-speed operating conditions of the vehicle. At this time, since the steering angular range of the wheel hub is relatively small, steering stability during high-speed travel of the vehicle can be readily ensured. That is, the present application ensures steering stability of the road wheel during high-speed travel while also enabling large-angle steering of the wheel during low-speed travel.

### BRIEF DESCRIPTION OF THE DRAWINGS

FIG. 1 is a structural schematic top view of a corner module dual-mode steering system equipped with two-stage steering according to an embodiment.

FIG. 2 is a structural schematic perspective view of a corner module dual-mode steering system equipped with two-stage steering according to an embodiment.

### REFERENCE SIGNS

100, suspension; 111, upper transverse arm; 112, first lower transverse arm; 113, second lower transverse arm; 114, first connection portion; 115, second connection portion;

210, primary drive mechanism; 220, primary transmission mechanism; 221, primary rocker arm; 222, primary connecting rod;

310, secondary drive mechanism; 320, secondary transmission mechanism; 321, secondary rocker arm; 322, secondary connecting rod;

400, wheel hub.

### DETAILED DESCRIPTION

The embodiments of the present application will be described in detail with reference to the accompanying drawings in order to make the objectives, features, and advantages of the present application clearer and more understandable. Many specific details are disclosed in the following description to facilitate a comprehensive understanding of the present application. However, the present application can be implemented in various ways different from those described herein, and those skilled in the art may make similar improvements without departing from the concept of the present application. Therefore, the present application is not limited to the specific embodiments disclosed below.

In the description of the present application, it should be understood that, when the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. appear, the orientation or position relationships indicated by these terms are based on the orientation or position relationships shown in the accompanying drawings and are intended to facilitate the description of the present application and simplify the description only, rather than indicating or implying that the apparatus or element referred to must have a particular orientation or be constructed and operated in a particular orientation, and therefore are not to be interpreted as limiting the present application.

In addition, when the terms “first” or “second” appear, these terms are used for descriptive purposes only, and cannot be construed as indicating or implying a relative importance, or implicitly specifying the number of the indicated technical features. Thus, the quantity of the feature defined with “first” or “second” may explicitly or implicitly be at least one. In the description of the present application, if the term “a plurality of” appears, it means at least two, such as two, three, unless otherwise defined explicitly and specifically.

In the present application, unless otherwise clearly specified and defined, the terms “installed”, “connected”, “coupled”, “fixed” and the like should be interpreted broadly. For example, the two elements may be fixedly connected, detachably connected, or integrated, may be mechanically connected or electrically connected, may be directly connected or connected via an intermediate element, and may be communicated or interacted, unless otherwise clearly specified and defined. For those of ordinary skill in the art, the specific meaning of the above-mentioned terms in the present application can be understood according to specific circumstances.

In the present application, unless otherwise specifically defined, a first feature, when being referred to as located “on” or “under” a second feature, may be in direct contact with the second feature or contact the second feature via an intermediate element. Moreover, a first feature, when being referred to as located “on”, “above”, or “over” a second feature, may be located right above or obliquely above the second feature, or merely located at a horizontal level higher than the second feature; a first feature, when being referred to as located “under”, “below”, or “beneath” a second feature, may be located right below or obliquely below the second feature, or merely located at a horizontal level lower than the second feature.

It should be noted that an element, when being referred to as “fixed” or “mounted” to another element, may be directly fixed or mounted to the other element or via an intermediate element. An element, when being referred to as “connected” to another element, may be directly connected to the other element or via an intermediate element. The terms such as “vertical”, “horizontal”, “up”, “down”, “left”, “right” and the like used herein are for illustrative purposes only and are not meant to be the only ways for implementing the present application.

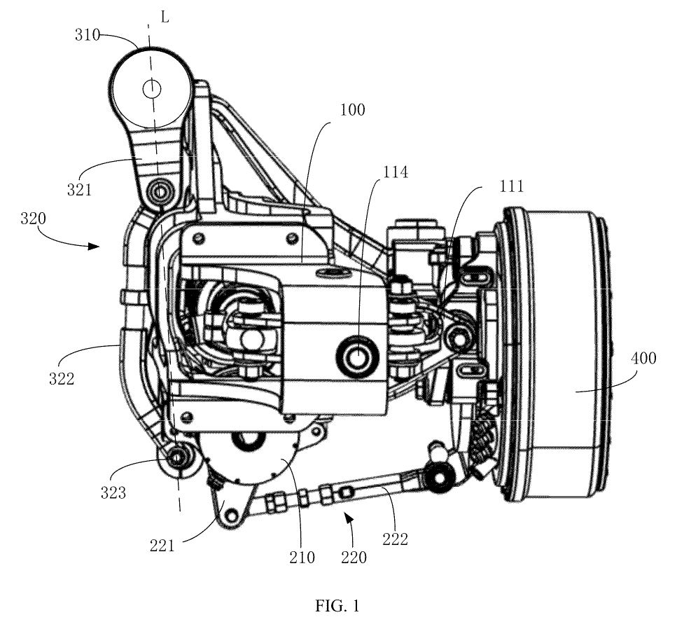

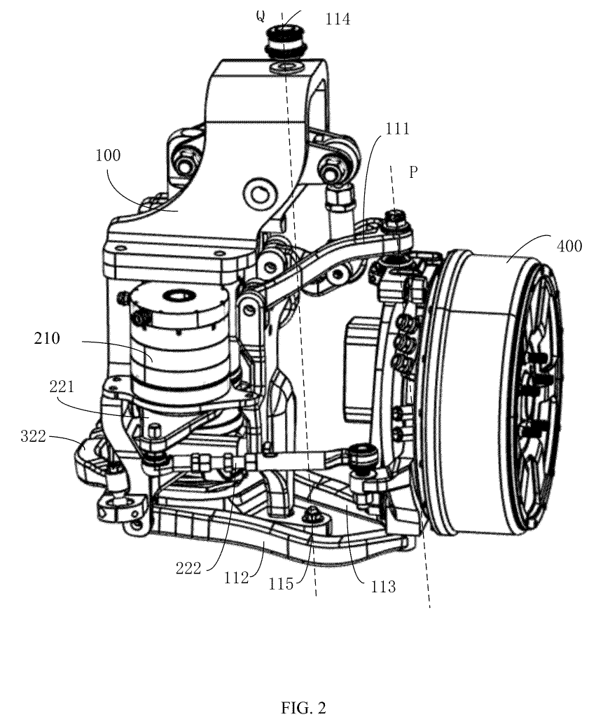

Referring to FIG. 1 and FIG. 2, an embodiment of the present application provides a corner module dual-mode steering system, which is equipped with two-stage steering. The system includes a suspension 100, a primary steering drive assembly, and a secondary steering drive assembly. The suspension 100 is configured to be connected between a vehicle frame and a wheel hub 400. The primary steering drive assembly includes a primary drive mechanism 210 and a primary transmission mechanism 220 connected to the primary drive mechanism 210. The primary drive mechanism 210 is fixed to the suspension 100. The primary transmission mechanism 220 is configured to be connected to the wheel hub 400. The primary drive mechanism 210 is configured to drive the primary transmission mechanism 220 to move, such that the primary transmission mechanism 220 causes the wheel hub 400 to steer relative to the suspension 100 within a first angular range. The secondary steering drive assembly includes a secondary drive mechanism 310 and a secondary transmission mechanism 320 connected to the secondary drive mechanism 310. The secondary drive mechanism 310 is configured to be fixed to the vehicle frame. The secondary transmission mechanism 320 is connected to the suspension 100. The secondary drive mechanism 310 is configured to drive, via the secondary transmission mechanism 320, the suspension 100 and the wheel hub 400 together to steer within a second angular range.

In the present embodiment, when the vehicle needs to park or make a turn under a low-speed condition, both the primary steering drive assembly and the secondary steering drive assembly are controlled to operate simultaneously, such that the primary drive mechanism 210 drives, via the primary transmission mechanism 220, the wheel hub 400 to steer within the first angular range, while the secondary drive mechanism 310 drives, via the secondary transmission mechanism 320, the suspension 100 and the wheel hub 400 to steer within the second angular range. That is, the total steering angular range of the wheel hub 400 is the sum of the first angular range and the second angular range, thereby significantly increasing the steering angular range of the wheel hub 400.

When the vehicle, at a medium or high speed, travels normally or makes a turn, only the primary steering drive assembly is controlled to operate. The primary steering drive assembly is configured to drive the wheel hub 400 to steer within a small angular range (i.e., the first angular range) so as to adapt to high-speed operating conditions of the vehicle. At this time, since the steering angular range of the wheel hub 400 is relatively small, steering stability during high-speed travel of the vehicle can be readily ensured. That is, the system of the present application ensures steering stability of the road wheel during high-speed travel while also enabling large-angle steering of the wheel during low-speed travel.

Furthermore, the primary transmission mechanism 220 and the secondary transmission mechanism 320 are independent from each other, thereby mechanically decoupling the primary steering drive assembly from the secondary steering drive assembly. Thus, when one assembly malfunctions, the other can still drive the wheel hub 400 to steer normally, thereby providing redundancy for a steer-by-wire system and improving steering reliability.

In some embodiments, the first angular range is -45° to +45°, and the second angular range is -45° to +45°.

In these embodiments, both the first angular range and the second angular range are -45° to +45°. That is, when the primary steering drive assembly and the secondary steering drive assembly simultaneously drive the wheel hub 400 to steer, the total steering angular range of the wheel hub 400 is -90° to +90°. Thus, during parking, the wheel hub 400 can make a turn by 90°, making the vehicle move laterally, thereby enabling rapid parking.

In some other embodiments, the first angular range is -30° to +30°, and the second angular range is -60° to +60°. When the primary steering drive assembly and the secondary steering drive assembly simultaneously drive the wheel hub 400 to steer, the total steering angular range of the wheel hub 400 is also -90° to +90°. That is, the first angular range and the second angular range can adopt different combinations. In some embodiments, the sum of the lower limit of the first angular range and the lower limit of the second angular range is -90°, and the sum of the upper limit of the first angular range and the upper limit of the second angular range is to +90°.

Under certain special operating conditions, the total steering angle can be made greater than 90° by adjusting the primary steering drive assembly or the secondary steering drive assembly.

In some embodiments, the suspension 100 and the primary transmission mechanism 220 are each spherically hinged to the wheel hub 400. The suspension 100 has a virtual kingpin axis P and is rotatably connected to the wheel hub 400 at the virtual kingpin axis P. The primary transmission mechanism 220 is configured to drive the wheel hub 400 to rotate about the virtual kingpin axis P.

The suspension 100 includes an upper transverse arm 111, a first lower transverse arm 112, and a second lower transverse arm 113. The upper transverse arm 111 is spherically hinged to an upper portion of the wheel hub 400 at a spherical hinge point. The first lower transverse arm 112 and the second lower transverse arm 113 are each spherically hinged to a bottom portion of the wheel hub 400. The extension lines of the first lower transverse arm 112 and the second lower transverse arm 113 intersect at an intersection point. The virtual kingpin axis P passes through the intersection point and the spherical hinge point where the upper transverse arm 111 is connected to the upper portion of the wheel hub 400.

The virtual kingpin axis P is an important parameter in an automobile chassis suspension system. The method for determining the virtual kingpin axis P is known in the art and will not be described in further detail herein.

In these embodiments, the wheel hub 400 is spherically hinged to the suspension 100, such that the suspension 100 can ensure stable mechanical support between the tire contact patch and the suspension system. On this basis, the primary transmission mechanism 220 is spherically hinged to the wheel hub 400, thereby enabling the primary transmission mechanism 220 to drive the wheel hub 400 to rotate about the virtual kingpin axis P, which ensures stable steering of the wheel hub 400.

Taking a four-wheeled vehicle as an example, the four-wheeled vehicle has two front wheels and two rear wheels, and the sides of the two front wheels or the two rear wheels that are closer to each other is defined as the inner sides. The suspensions 100 are disposed on the inner sides of the wheel hubs 400.

In some other embodiments, the corner module dual-mode steering system equipped with two-stage steering according to the present application can also be applied to two-wheeled, three-wheeled, five-wheeled, and other multi-wheeled vehicles.

In some embodiments, the primary transmission mechanism 220 includes a primary rocker arm 221 and a primary connecting rod 222 that are sequentially connected. One end of the primary rocker arm 221 away from the primary connecting rod 222 is connected to the primary drive mechanism 210, and one end of the primary connecting rod 222 away from the primary rocker arm 221 is spherically hinged to the wheel hub 400.

In some embodiments, the primary drive mechanism 210 is an electric motor. The electric motor is disposed on the suspension 100. The electric motor is configured to drive the primary rocker arm 221 to swing in a horizontal plane, so as to cause the primary connecting rod 222 to swing via the primary rocker arm 221, thereby enabling the wheel hub 400 to rotate about the virtual kingpin axis P. The primary transmission mechanism 220 adopts the primary rocker arm 221 and the primary connecting rod 222 for transmission, which can optimize the steering force distribution and comprehensively improve high-speed steering stability.

In some other embodiments, the primary drive mechanism 210 is a pneumatic cylinder, and the primary transmission mechanism 220 is a telescopic rod. Through extension and retraction of the telescopic rod, the wheel hub 400 can be directly driven to rotate about the virtual kingpin axis P.

In some embodiments, the length of the primary connecting rod 222 is adjustable.

In these embodiments, the length of the primary connecting rod 222 is adjusted to change the initial phase angle of the primary drive mechanism 210, that is, to change the first angular range, so as to accommodate different vehicle installation requirements, e.g., the first angular range can be changed from the range of -45° to +45° to the range of -40° to +50°.

In some embodiments, the suspension 100 includes a first connection portion 114 and a second connection portion 115. The first connection portion 114 and the second connection portion 115 are each configured to be spherically hinged to the vehicle frame. The line connecting the first connection portion 114 and the second connection portion 115 constitutes a virtual secondary kingpin axis Q, and the secondary transmission mechanism 320 is configured to drive the suspension 100 to rotate about the virtual secondary kingpin axis Q.

The virtual kingpin axis P satisfies the condition that, when the wheel hub 400 is at a 90° steering angle, the wheel hub 400 is perpendicular to the ground. After the position of the virtual kingpin axis P is determined, first, based on the installable ranges of the first connection portion 114 and the second connection portion 115 (which are limited by the spatial constraints of the vehicle frame), a set of candidate axes satisfying the conditions is determined using a matrix calculation method for axes. Then, Adams software is used to simulate and verify whether an axis in an actual model satisfies the set conditions. If the conditions are met, the position of the virtual secondary kingpin axis Q is obtained. Finally, the specific positions of the first connection portion 114 and the second connection portion 115 are determined based on the position of the virtual secondary kingpin axis Q.

In these embodiments, the secondary drive mechanism 310 is fixed to the vehicle frame. The secondary drive mechanism 310 is configured to drive, via the secondary transmission mechanism 320, the suspension 100 to rotate about the virtual secondary kingpin axis Q, thereby further increasing the steering angular range of the wheel hub 400 on the basis of the rotation of the wheel hub 400 driven by the primary transmission mechanism 220.

In some embodiments, the first connection portion 114 is located at one end of the suspension 100 in the vertical direction, and the second connection portion 115 is located at the other end of the suspension 100 in the vertical direction. Along the vertical direction, the secondary transmission mechanism 320 is disposed between the first connection portion 114 and the second connection portion 115.

In these embodiments, the upper portion of the suspension 100 is spherically hinged to the vehicle frame via the first connection portion 114, and the bottom portion of the suspension 100 is spherically hinged to the vehicle frame via the second connection portion 115, thereby improving the stability of the connection between the suspension 100 and the vehicle frame. On this basis, the secondary transmission mechanism 320 is located between the first connection portion 114 and the second connection portion 115 in the vertical direction, which can effectively enhance the driving stability of the secondary steering drive assembly.

In some embodiments, the secondary transmission mechanism 320 is disposed on the side of the suspension 100 away from the wheel hub 400. That is, the secondary transmission mechanism 320 is installed in the space between the two front wheels or the two rear wheels, thereby effectively utilizing the space between the two wheel hubs and achieving a compact structure.

Specifically, the secondary transmission mechanism 320 includes a secondary rocker arm 321 and a secondary connecting rod 322 that are sequentially connected. One end of the secondary rocker arm 321 away from the secondary connecting rod 322 is connected to the secondary drive mechanism 310, and one end of the secondary connecting rod 322 away from the secondary rocker arm 321 is spherically hinged to the suspension 100.

In some embodiments, the secondary drive mechanism 310 is an electric motor. The electric motor is fixed to the vehicle frame. The electric motor is configured to drive the secondary rocker arm 321 to swing in a horizontal plane, so as to cause the secondary connecting rod 322 to swing relative to the suspension 100, thereby enabling the suspension 100 and the wheel hub 400 to rotate about the virtual secondary kingpin axis Q.

In some other embodiments, the secondary drive mechanism is a pneumatic cylinder, and the secondary transmission mechanism is a telescopic rod. Through extension and retraction of the telescopic rod, the suspension 100 can be directly driven to rotate about the virtual secondary kingpin axis Q.

Further, referring to FIG. 1, the secondary transmission mechanism 320 has a locked state. In the locked state of the secondary transmission mechanism 320, the rotation center of the secondary drive mechanism 310 (e.g., the center the secondary rocker arm 321 swings about), the connection point between the secondary rocker arm 321 and the secondary connecting rod 322, and the connection point 323 between the secondary connecting rod 322 and the suspension 100 lie on the same straight line L.

In the present embodiment, when the vehicle is in the high-speed driving state, the secondary steering drive assembly is not required, and the secondary transmission mechanism 320 can be locked. Specifically, in the locked state of the secondary transmission mechanism 320, the rotation center of the secondary drive mechanism 310, the connection point between the secondary rocker arm 321 and the secondary connecting rod 322, and the connection point between the secondary connecting rod 322 and the suspension 100 are aligned on the same straight line L. At this time, road surface forces transmitted through the primary connecting rod 222 do not generate additional torque on the secondary drive mechanism 310. Moreover, the self-locking of the secondary transmission mechanism 320 does not affect the operation of the primary transmission mechanism 220, thereby achieving mutual decoupling between the primary steering drive assembly and the secondary steering drive assembly, and further enhancing stability during high-speed driving and conventional steering.

In some embodiments, the length of the secondary connecting rod 322 is adjustable.

In these embodiments, the length of the secondary connecting rod 322 is adjusted to change the initial phase angle of the secondary drive mechanism 310, that is, to change the second angular range, so as to accommodate different vehicle installation requirements, e.g., the second angular range can be changed from the range of -45° to +45° to the range of -40° to +50°.

An embodiment of the present application further provides a vehicle including a vehicle frame, the corner module dual-mode steering system equipped with two-stage steering as described above, and a wheel hub 400. The suspension 100 is rotatably disposed on the vehicle frame, and the wheel hub 400 is rotatably disposed on the suspension 100. The primary drive mechanism 210 is fixed to the suspension 100. The primary transmission mechanism 220 is connected to the wheel hub 400. The primary drive mechanism 210 is configured to drive, via the primary transmission mechanism 220, the wheel hub 400 to steer within the first angular range. The secondary drive mechanism 310 is fixed to the vehicle frame. The secondary transmission mechanism 320 is connected to the suspension 100. The secondary drive mechanism 310 is configured to drive, via the secondary transmission mechanism 320, the suspension 100 and the wheel hub 400 to steer within the second angular range.

An embodiment of the present application further provides a driving method for the corner module dual-mode steering system equipped with two-stage steering, wherein the corner module dual-mode steering system has a first operating state and a second operating state.

When the corner module dual-mode steering system is in the first operating state, the driving method includes the steps of: driving, via the primary drive mechanism 210, the primary transmission mechanism 220 to move, and driving, via the primary transmission mechanism 220, the wheel hub 400 to steer within the first angular range. The first operating state may correspond to conditions where the vehicle is traveling at medium to high speeds or requires conventional steering.

When the corner module dual-mode steering system is in the second operating state, the driving method includes the steps of: driving, via the primary drive mechanism 210, the primary transmission mechanism 220 to move, and driving, via the primary transmission mechanism 220, the wheel hub 400 to steer within the first angular range; driving, via the secondary drive mechanism 310, the secondary transmission mechanism 320 to move, and driving, via the secondary transmission mechanism 320, the suspension 100 and the wheel hub 400 to steer simultaneously within the second angular range. The second operating state may correspond to conditions where the vehicle is parking or making a turn at a low speed.

In the present embodiment, when the vehicle needs to park or make a turn under a low-speed condition, both the primary steering drive assembly and the secondary steering drive assembly are controlled to operate simultaneously, such that the primary drive mechanism 210 drives, via the primary transmission mechanism 220, the wheel hub 400 to rotate within the first angular range, while the secondary drive mechanism 310 drives, via the secondary transmission mechanism 320, the suspension 100 and the wheel hub 400 to steer within the second angular range. That is, the total steering angular angle of the wheel hub 400 is the sum of the first angular range and the second angular range, which significantly increases the steering angular angle of the wheel hub 400 while still ensuring the stability of the wheel hub 400.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

What is claimed is:

1. A corner module dual-mode steering system equipped with two-stage steering, comprising:
a suspension configured to be connected between a vehicle frame and a wheel hub;
a primary steering drive assembly comprising a primary drive mechanism and a primary transmission mechanism connected to the primary drive mechanism, the primary drive mechanism being fixed to the suspension, the primary transmission mechanism being configured to be connected to the wheel hub, and the primary drive mechanism being configured to drive the primary transmission mechanism to move, such that the primary transmission mechanism causes the wheel hub to steer relative to the suspension within a first angular range;
a secondary steering drive assembly comprising a secondary drive mechanism and a secondary transmission mechanism connected to the secondary drive mechanism, the secondary drive mechanism being configured to be fixed to the vehicle frame, the secondary transmission mechanism being connected to the suspension, and the secondary drive mechanism being configured to drive the secondary transmission mechanism to move, such that the secondary transmission mechanism causes the suspension and the wheel hub together to steer within a second angular range.

2. The corner module dual-mode steering system equipped with two-stage steering according to claim 1, wherein the suspension and the primary transmission mechanism are each spherically hinged to the wheel hub;
the suspension has a virtual kingpin axis and is rotatably connected to the wheel hub at the virtual kingpin axis, and the primary transmission mechanism is configured to drive the wheel hub to rotate about the virtual kingpin axis.

3. The corner module dual-mode steering system equipped with two-stage steering according to claim 2, wherein the suspension comprises an upper transverse arm, a first lower transverse arm, and a second lower transverse arm;
the upper transverse arm is spherically hinged to an upper portion of the wheel hub at a spherical hinge point;
the first lower transverse arm and the second lower transverse arm are each spherically hinged to a bottom portion of the wheel hub, and extension lines of the first lower transverse arm and the second lower transverse arm intersect at an intersection point;
the virtual kingpin axis passes through the intersection point and the spherical hinge point.

4. The corner module dual-mode steering system equipped with two-stage steering according to claim 2, wherein the primary transmission mechanism comprises a primary rocker arm and a primary connecting rod that are sequentially connected; one end of the primary rocker arm away from the primary connecting rod is connected to the primary drive mechanism, and one end of the primary connecting rod away from the primary rocker arm is spherically hinged to the wheel hub.

5. The corner module dual-mode steering system equipped with two-stage steering according to claim 4, wherein the primary drive mechanism is an electric motor configured to drive the primary rocker arm to swing in a horizontal plane.

6. The corner module dual-mode steering system equipped with two-stage steering according to claim 4, wherein a length of the primary connecting rod is adjustable.

7. The corner module dual-mode steering system equipped with two-stage steering according to claim 1, wherein the suspension comprises a first connection portion and a second connection portion, the first connection portion and the second connection portion are each configured to be spherically hinged to the vehicle frame, a line connecting the first connection portion and the second connection portion is defined as a virtual secondary kingpin axis, and the secondary transmission mechanism is configured to drive the suspension and the wheel hub to rotate simultaneously about the virtual secondary kingpin axis.

8. The corner module dual-mode steering system equipped with two-stage steering according to claim 7, wherein the first connection portion is located at one end of the suspension in a vertical direction, the second connection portion is located at another end of the suspension in the vertical direction, and along the vertical direction, the secondary transmission mechanism is disposed between the first connection portion and the second connection portion.

9. The corner module dual-mode steering system equipped with two-stage steering according to claim 7, wherein the secondary transmission mechanism is disposed on a side of the suspension away from the wheel hub.

10. The corner module dual-mode steering system equipped with two-stage steering according to claim 9, wherein the secondary transmission mechanism comprises a secondary rocker arm and a secondary connecting rod that are connected, one end of the secondary rocker arm away from the secondary connecting rod is connected to the secondary drive mechanism, and one end of the secondary connecting rod away from the secondary rocker arm is spherically hinged to the suspension.

11. The corner module dual-mode steering system equipped with two-stage steering according to claim 10, wherein the secondary drive mechanism is an electric motor configured to drive the secondary rocker arm to swing in a horizontal plane.

12. The corner module dual-mode steering system equipped with two-stage steering according to claim 10, wherein the secondary transmission mechanism has a locked state, and in the locked state of the secondary transmission mechanism, a rotation center of the secondary drive mechanism, a connection point between the secondary rocker arm and the secondary connecting rod, and a connection point between the secondary connecting rod and the suspension lie on a same straight line.

13. The corner module dual-mode steering system equipped with two-stage steering according to claim 10, wherein a length of the secondary connecting rod is adjustable.

14. The corner module dual-mode steering system equipped with two-stage steering according to claim 1, wherein the first angular range is -45° to +45°, and the second angular range is -45° to +45°.

15. The corner module dual-mode steering system equipped with two-stage steering according to claim 1, wherein a sum of a lower limit of the first angular range and a lower limit of the second angular range is -90°, and a sum of an upper limit of the first angular range and an upper limit of the second angular range is to +90°.

16. A vehicle comprising a vehicle frame, a wheel hub, and the corner module dual-mode steering system equipped with two-stage steering according to claim 1, wherein the suspension is rotatably disposed on the vehicle frame, and the wheel hub is rotatably disposed on the suspension.

17. A method for driving the corner module dual-mode steering system equipped with two-stage steering according to claim 1, wherein the corner module dual-mode steering system has a first operating state and a second operating state,
when the corner module dual-mode steering system is in the first operating state, the method comprises:
driving, via the primary drive mechanism, the primary transmission mechanism to move, and driving, via the primary transmission mechanism, the wheel hub to steer within the first angular range;
when the corner module dual-mode steering system is in the second operating state, the method comprises:
driving, via the primary drive mechanism, the primary transmission mechanism to move, and driving, via the primary transmission mechanism, the wheel hub to steer within the first angular range; driving, via the secondary drive mechanism, the secondary transmission mechanism to move, and driving, via the secondary transmission mechanism, the suspension and the wheel hub to steer simultaneously within the second angular range.
